(19) United States
(12) Patent Application Publication
(10) Pub. No.: US 2016/0133925 A1
(43) Pub. Date: May 12, 2016

(54) FULLERENE-LIKE NANOPARTICLES AND INORGANIC NANOTUBES AS HOST ELECTRODE MATERIALS FOR SODIUM/MAGNESIUM ION BATTERIES

(71) Applicant: YEDA RESEARCH AND DEVELOPMENT CO. LTD., Rehovot (IL)

(72) Inventors: Reshef TENNE, Rehovot (IL); Rita ROSENTSVEIG, Rehovot (IL); Lena YADGAROV, Rehovot (IL); Sung You HONG, Rehovot (IL); Kyu Tae LEE, Rehovot (IL)

(21) Appl. No.: 14/973,152

(22) Filed: Dec. 17, 2015

Related U.S. Application Data
(63) Continuation-in-part of application No. PCT/IL2014/050550, filed on Jun. 18, 2014.
(60) Provisional application No. 61/836,359, filed on Jun. 18, 2013.

(51) Int. Cl. H01M 4/36; H02J 7/00; H01M 10/44; H01M 4/62; H01M 4/58; H01M 10/054

(52) U.S. Cl. CPC H01M 4/366; H01M 4/581; H01M 10/054; H01M 10/446; H01M 4/623; H01M 4/625; H02J 7/0052; H01M 2004/028

(57) ABSTRACT

The invention generally concerns the fabrication of sodium or magnesium ion batteries comprising inorganic fullerene like nanoparticles and nanotubes.

### CROSS-REFERENCE TO RELATED APPLICATIONS

This application is a Continuation-in-Part of PCT International Application No. PCT/IL2014/050550, International Filing Date Jun. 18, 2014, which claims priority of U.S. Provisional Patent Application No. 61/836,359, filed Jun. 18, 2013 which are hereby incorporated by reference, in their entirety.

### FIELD OF THE INVENTION

The invention generally concerns fullerene-like nanoparticles and inorganic nanotubes intercalating sodium or magnesium ions for use in the fabrication of sodium or magnesium ion batteries.

### BACKGROUND

On the basis of the low toxicity and abundant resources compared to lithium ion batteries, sodium ion batteries are regarded as attractive new generation batteries. However, there have been few reports on successfully produced electrode materials for reversible sodium ion intercalation [1-7]. Having a small ionic radius, lithium ions easily intercalates into transition metal oxides including LiCoO₂, LiNiO₂, and LiMn₂O₄. In contrast, the radius of sodium ion (102 pm) is ca. 1.34 times larger than that of lithium ions (76 pm) resulting in steric hindrance of the intercalation of sodium ions to interstitial spaces of crystalline sodium-based oxide materials.

Ceder et al [8] explained the facile lithium ion intercalation at the enthalpy point. Since the formation energy of Li₂O (−599 kJ/mol) is much greater than that of Na₂O (−418 kJ/mol), lithium ion insertion to the oxide layer is favored as compared to sodium ion insertion. When transition metal sulfides (TMS) are utilized as host materials, however, sodium ion insertion to interstitial sites is favored due to the relatively small differences in the formation enthalpies of Li₂S (−466 kJ/mol) and Na₂S (−336 kJ/mol). Accordingly, metal sulfides are considered a promising electrode material for sodium ion batteries.

Previously, sodium ion intercalation into nanostructures has been achieved by using methods such as immersion in metal-ammonia solutions, exfoliation and restacking, and exposure to metal vapors; these methods have proven unfavorable due to the simultaneous intercalation of solvent molecules into the nanostructures [9-10].

There have been few reports on sodium ion rechargeable batteries using TMS as electrode materials, [11-13] although various sulfide compounds have been examined as hosts of lithium-ion intercalation for rechargeable batteries [14-17].

### REFERENCES

References considered to be relevant as background to the presently disclosed subject matter are listed below:
[1] K. T. Lee et al., Chemistry of Materials, 2011, 23, 3593-3600.
[2] J. M. Tarascon et al., Solid State Ionics, 1992, 57, 113-120.
[3] M. M. Doeffet al., Journal of the Electrochemical Society, 1994, 141, L145-L147.
[4] C. H. Zhang et al., Nature Materials, 2009, 8, 580-584.
[5] D. Kim et al., Advanced Energy Materials, 2011, 1, 333-336.
[6] S. Komaba et al., Electrochemistry Communications, 2010, 12, 355-358.
[7] N. Recham et al., Journal of the Electrochemical Society, 2009, 156, A993-A999.
[8] S. P. Ong et al., Energy & Environmental Science, 2011, 4, 3680-3688.
[9] A. Zak et al., Journal of the American Chemical Society, 2002, 124, 4747-4758.
[10] F. Kopnov et al., Chemistry of Materials, 2008, 20, 4099-4105.
[11] J. Part et al., Electrochimica Acta, 2013, 92, 427-432.
[12] W.-H. Ryu et al., Nanoscale, 2014, Accepted Manuscript. DOI: 10.1039/C4NR02044H
[13] L. David et al., ACS Nano, 2014, 2, 1759-1770.
[14] M. S. Whittingham, Science, 1976, 192, 1126-1127.
[15] C. Feng et al., Materials Research Bulletin, 2009, 44, 1811-1815.
[16] R. Dominko et al., Advanced Materials, 2002, 14 (21), 1531-1534.
[17] C. Zhai et al., Chemical Communications, 2011, 47, 1270-1272.
[18] L. Yadgarov et al., Angewandte Chemie-International Edition, 2012, 51, 1148-1151.
[19] L. Margulis et al., Nature, 1993, 365, 113-114.
[20] U.S. Pat. No. 5,958,358.
[21] WO 01/66462.
[22] WO 01/66676.
[23] WO 02/34959.
[24] WO 00/66485.
[25] WO 98/23796.
[26] WO06/106517.

### SUMMARY OF THE INVENTION

Herein, the inventors of the present invention disclose a process for intercalation of sodium or magnesium ions within inorganic fullerene-like nanoparticles and nanotubes, for the construction of sodium/magnesium ion batteries exhibiting excellent electrochemical performance The inventors' ability to intercalate ions within the fullerene-like structures is surprising, as prior attempts have been found fruitless (even in the cases of lithium ion batteries). This is due to the closed cage shell of the fullerene structure, which renders the particles with poor accessibility of ion intercalation into inner shells. It was found that, unlike the case of C₆₀ fullerene, fullerene-like structures of compounds such as MoS₂, permit diffusion of sodium ion or magnesium ion through defective channels of the closed crystal structures, resulting in increased ion permeability.

Thus, in a first aspect of the invention, there is provided a process for electrochemically intercalating sodium ion(s) into nanostructures, such as inorganic multilayered nanostructures (inorganic fullerene-like (IF)-nanoparticles and inorganic nanotubes—INT), the process comprising imposing a current to an electrode material, the electrode material comprising said inorganic multilayered nanostructures (IF-nanoparticles or INTs), wherein said current has a current density suitable to induce such intercalation.

In another aspects of the invention, there is provided a process for electrochemically intercalating magnesium ion(s) into nanostructures, such as inorganic multilayered nanostructures (inorganic fullerene-like (IF)-nanoparticles and inorganic nanotubes—INT), the process comprising imposing a current to an electrode material, the electrode material comprising said inorganic multilayered nanostructures (IF-nanoparticles or INTs), wherein said current has a current density suitable to induce such intercalation.

In some embodiments, the current density may be between about 20 mAg⁻¹ and 4000 mAg⁻¹. Without wishing to be bound by theory, such a current density allows for the mobilization of sodium ions from an electrolyte to the electrode, typically a cathode, comprising the multilayered nanostructures.

In some embodiments, the electrochemically driven ion intercalation is achievable in an electrochemical cell. The electrochemical intercalation may be achievable by applying an electrical current to an electrical circuit being composed of a cathode comprising the inorganic multilayered nanostructures (e.g., IF-nanoparticles, INTs or any combination thereof) and an anode, the cathode and anode being at least partially submerged within an electrolyte comprising sodium ions, to thereby intercalate the ions into the nanostructures.

In some embodiments, the intercalation is reversible, as will be further discussed below.

As may be understood, the intercalation is in operando, namely the intercalation process takes place during electrical cycling, e.g. during the operation of a process of the invention. Upon arresting of current supply, intercalation of the sodium or magnesium ions into the nanostructures is no longer facilitated.

In another aspect, there is provided a process for an in operando intercalation of at least one sodium ion in inorganic multilayered nanostructures.

The ability of the inorganic multilayered nanostructures to intercalate metal ions, e.g., Na⁺ or Mg²⁺ ions, render them suitable materials for sodium-based energy storage device, e.g., batteries. Sodium being a cheap, nontoxic and abundant element is ideal as a transport ion for rechargeable energy storage devices.

Thus, the invention also contemplates an intercalation electrode material comprising inorganic multilayered-nanoparticles and at least one of carbon black, fluoropolymer or mixtures thereof, the material having the capability of intercalating (capture) and de-intercalating (release) sodium ions during an electrical charge-discharge cycle.

In a charge-discharge cycle characteristic of sodium-ion (or magnesium-ion) energy storage device, the sodium-ions are initially released (de-intercalated) from the cathode containing the IF nanostructures and transferred to the anode (charge). During discharge, sodium ions from the anode pass through the liquid electrolyte to the electrochemically active cathode where the ions are intercalated in the IF/INT nanostructures, with the simultaneous release of electrical energy.

In accordance with the present invention, an energy storage device, e.g., a battery, comprises an electrode assembly, cathode and an anode, and an electrolyte (in a non-aqueous medium), wherein an electrode of said electrode assembly, e.g., the cathode, comprises nanostructures, as defined herein. The nanostructures, when formulated into a cathode composition, are further capable of reversibly cycling sodium ions between the cathode and the anode. The anode is typically graphite-based and does not contain any nanostructures. In some embodiments, the energy storage device further comprises a membrane separating the anode from the cathode.

The invention also provides an electrode, i.e. a cathode, comprising inorganic multilayered nanostructures, as defined herein, the nanostructures being capable of intercalating and de-intercalating sodium or magnesium ions.

As used herein, the term “intercalation” or any lingual variation thereof, refers to the ability of a sodium metal ion to be inserted (or intercalated within) and released (extracted) from the inorganic multilayered nanostructure (IF/INT), as defined herein. Without wishing to be bound by theory, the intercalation mechanism involves electron transfer, where the intercalation of sodium ions stabilizes a negative charge (electron) on the nanostructure, thereby resulting in a relatively stable structure.

The “nanostructures” being part of the cathode of the invention are inorganic multilayered nanostructures, which are multiwall closed-cage (fullerene-like) nanoparticles (i.e. IF-nanoparticles) or nanotubes (INTs) or mixtures thereof; the nanostructures are of metal (or transition metal) chalcogenides, and, in some embodiments, having the general formula M-chalcogenide, wherein M is a metal or a transition metal or an alloy thereof and the chalcogenide atom is selected from S, Se and Te.

In some embodiments, M may be selected from a metal or transition metal or an alloy of metals or transition metals selected from Mo, W, Re, Ti, Zr, Hf, Nb, Ta, Pt, Ru, Rh, In, Ga, Sn, Pb, and alloys thereof.

In other embodiments, the M-chalcogenide is of the general structure MX₂, wherein M is a metal or transition metal or an alloy of metals or transition metals; and X is a chalcogenide atom, which may, in some embodiments be selected from S, Se, and Te.

In some embodiments, the M-chalcogenide is selected from MoS₂ and RuS₂.

In some other embodiments, M is of the general structure A₁₋ₓ-Bₓ, and thus the metal chalcogenide is of the general structure A₁₋ₓ-Bₓ-chalcogenide, wherein A is a metal atom or transition metal atom or an alloy of metal atoms or transition metal atoms, said atom being selected from Mo, W, Re, Ti, Zr, Hf, Nb, Ta, Pt, Ru, Rh, In, Ga, Sn, Pb, and alloys such as WₓMo₁₋ₓ, etc; B is a metal atom or transition metal atom, said atom being selected from Si, Li, Nb, Ta, W, Mo, Sc, Y, Hf, Ir, Mn, Ru, Re, Os, V, Au, Rh, Pd, Cr, Co, Fe and Ni, Sn, Pb, and wherein x being ≦0.3, provided that x is not zero and A≠B.

In some embodiments, M is Mo₁₋ₓNbₓ.

In other embodiments, x is below 0.1 (i.e. 0<x≦0.1), below 0.01 (i.e. 0<x≦0.01), or below 0.005 (i.e. 0<x≦0.005).

In a nanostructure employed according to the invention, Bx and/or B-chalcogenide are incorporated within A₁₋ₓ-chalcogenide. The doping of Bₓ in the lattice of the A₁₋ₓ-chalcogenide produces changes in the electronic properties leading to the formation of high conductivity semiconductors, which are capable of transporting electrical charges.

The substitution of B in A may be continuous or alternate substitutions. Continuous substitution are spreads of A and B within each layer alternating randomly (e.g. (A)ₙ-(B)ₙ, n>1). Depending on the concentration of incorporated B, it may replace a single A atom within A₁₋ₓ-chalcogenide matrix forming a structure of ( . . . A)n-B-(A)n-B . . . ). Alternate substitution means that A and B are alternately incorporated into the A₁₋ₓ-chalcogenide lattice ( . . . A-B-A-B . . . ). It should be noted that other modes of substitution of the B in the A-chalcogenide lattice are possible according to the invention. Since the A-chalcogenide has a layered structure, the substitution may be done randomly in the lattice or every 2, 3, 4, 5, 6, 7, 8, 9 or 10 layers.

In some embodiments, the nanostructures employed in the invention have 10 or more layers, 20 or more layers, 30 or more layers, or up to 50 layers.

The nanostructures may be prepared by any one method known, for examples processes disclosed in U.S. Pat. Nos. 5,958,358, WO 01/66462, WO 01/66676, WO 02/34959, WO 00/66485, WO 98/23796 and WO06/106517, each of the processes disclosed in the aforementioned applications (US corresponding application or otherwise) are incorporated herein by reference.

The nanostructures may be further selected amongst doped metal-chalcogenides. In some embodiments, the doped nanostructures are metal-chalcogenides doped with, e.g., Re or Nb.

In some embodiments, the IF nanostructure is selected from Re doped IF-MoS₂ (abbreviated Re:IF-MoS₂), Re doped IF-WS₂ (abbreviated Re:IF-WS₂), Nb doped IF-MoS₂ (abbreviated Nb:IF-MoS₂) and Nb doped IF-WS₂ (abbreviated Nb:IF-WS₂) and the respective Re:INT-MS₂ and Nb:INT-MS₂.

In other embodiments, the nanostructures are metal-chalcogenides alloyed with, e.g., Fe or Co. In such embodiments, the nanostructure is selected from Fe alloyed IF-TiS₂ (abbreviated Fe:IF-TiS₂), and Co alloyed IF-MoS₂ (abbreviated Co:IF-MoS₂).

In some embodiments, the cathode further comprises a carbonaceous material which increases the electrical conductivity, typically being carbon black, or graphene or CNT.

In further embodiments, the cathode may further comprise a polymer which serves as a binder. In such embodiments, the polymer is a fluoropolymer, which may be selected from polyvinylidene fluoride, polytetrafluoroethylene, P(VDF-trifluoroethylene) copolymer, P(VDF-tetrafluoroethylene) copolymer, fluorinated ethylene-propylene, polyethylene-tetrafluoroethylene, perfluoropolyether, and combinations thereof.

In some embodiments, the fluoropolymer is polyvinylidene fluoride.

In accordance with some embodiments, although not limited thereto, the cathode comprises 70 wt % nanostructures (typically IF-nanoparticles), 15 wt % carbon black and 15 wt % polyvinylidene fluoride.

As noted above, an anode is used in the process of the invention. In some embodiments, the anode comprises a carbonaceous material, which may, by some embodiments, be graphite.

In the process of the invention, the cathode and the anode are at least partially, at times entirely, submerged in an electrolyte. In some embodiments, the electrolyte comprises sodium or magnesium ions in a non-aqueous liquid medium. In such embodiments, the non-aqueous liquid medium may be selected from ethylene carbonate, diethyl carbonate and mixtures thereof.

In other embodiments, the sodium-ion concentration in the electrolyte is about 0.5-1 M (NaClO₄ salt) in an ethylene carbonate and diethyl carbonate (1:1, v/v).

In additional embodiments, the electrical circuit used in the process of the invention is an electrochemical cell or an energy storage device.

According to some embodiments, the voltage generating the electrical current utilized in a process of the invention is cycled between about 0.4 and 2.7 V (vs. Na/Na⁺).

In such embodiments, said cycling is carried out at a current density of between 15 and 25 mAg⁻1, and at a temperature of between about 20 and 35° C. In some embodiments, the temperature is 30° C.

In another aspect, the invention provides an electrochemical cell for use in intercalating sodium ions into inorganic multilayered nanostructures comprising a cathode and an anode, the cathode comprising the inorganic multilayered nanostructures, the cathode and anode being at least partially submerged within an electrolyte comprising sodium ions.

In a further aspect, the invention provides an electrochemical cell for use in intercalating magnesium ions into inorganic multilayered nanostructures comprising a cathode and an anode, the cathode comprising the inorganic multilayered nanostructures, the cathode and anode being at least partially submerged within an electrolyte comprising magnesium ions.

Another aspect of the invention provides a sodium ion cell comprising the electrochemical cell of the invention as described herein.

Yet another aspect of the invention provides a magnesium ion cell comprising the electrochemical cell of the invention as described herein.

In a further aspect, the invention provides a kit for preparing a sodium or a magnesium cell, the kit comprising:
a cathode material comprising inorganic multilayered nanostructures and at least one of carbon black and a fluoropolymer;
graphite as an anode material; and
an electrolyte comprising a non-aqueous liquid medium and sodium or magnesium ions; and
optionally comprising an electric voltage source and means for connecting said electric voltage source to said cathode and anode.

The energy storage device, e.g. battery, according to the present invention may be utilized in a variety of applications, including portable electronics, such as cell phones, music players, tablet computers, video cameras; power tools for a variety of applications, such as power tools for military applications, for aerospace applications, for vehicle applications, for medical applications, and others.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-D present SEM images of: FIG. 1A—IF-MoS₂ and FIG. 1B—Re:IF-MoS₂. TEM images of: FIG. 1C—IF-MoS₂ and FIG. 1D—Re:IF-MoS₂.

FIG. 2 presents SEM image of INT-WS₂.

FIG. 3 presents XRD patterns of IF-MoS₂, Re:IF-MoS₂ and bulk 2H-MoS₂. The asterisk corresponds to peak of a sample holder.

FIGS. 4A-F demonstrate electrochemical performances. FIG. 4A—cycle performance of IF-MoS₂ and Re:IF-MoS₂, and their corresponding voltage profiles: FIG. 4B—Re:IF-MoS₂, FIG. 4C—IF-MoS₂, FIG. 4D—rate performance of IF-MoS₂ and Re:IF-MoS₂, and their corresponding voltage profiles: FIG. 4E—Re:IF-MoS₂ and FIG. 4F—IF-MoS₂.

FIGS. 5A-B show ex-situ XRD patterns of IF-MoS₂ electrodes collected at various points during electrochemical cycling: the corresponding FIG. 5A voltage profiles and FIG. 5B XRD patterns. The asterisk corresponds to peak of a sample holder.

### DETAILED DESCRIPTION OF EMBODIMENTS

In one embodiment, this invention provides an electrode comprising inorganic multilayered nanostructures wherein the inorganic multilayered nanostructures are selected from inorganic fullerene-like nanoparticles (IF-nanoparticles), inorganic nanotubes (INTs), and any combination thereof;
wherein the nanostructures are of the formula MXₙ, wherein M is of the general formula A₁₋ₓ-Bₓ,
wherein x being ≦0.3, provided that x is not zero and A≠B, wherein
X is a chalcogenide atom selected from S, Se and Te;
   A is a metal atom or transition metal atom or an alloy of metal atoms or transition metal atoms;
   B is a metal atom or transition metal atom; and
n is an integer selected from 1 and 2.

In one embodiment, A is a metal atom or transition metal atom or an alloy of metal atoms or transition metal atoms, the atom being selected from Mo, W, Re, Ti, Zr, Hf, Nb, Ta, Pt, Ru, Rh, In, Ga, Sn, Pb, and alloys thereof.

In one embodiment B is a metal atom or transition metal atom, the atom being selected from Si, Li, Nb, Ta, W, Mo, Sc, Y, Hf, Ir, Mn, Ru, Re, Os, V, Au, Rh, Pd, Cr, Co, Fe and Ni.

In one embodiment B is a metal atom or transition metal atom, the atom being selected from Si, Nb, Ta, W, Mo, Sc, Y, Hf, Ir, Mn, Ru, Re, Os, V, Au, Rh, Pd, Cr, Co, Fe and Ni.

In one embodiment, the nanostructures are doped with a B element selected from Re and Nb or alloyed with a B element selected from Fe and Co.

In one embodiment, the electrode further comprises a carbonaceous material, a fluoropolymer or mixtures thereof. In one embodiment, the carbonaceous material is selected from carbon black, carbon nanotubes and graphene. In one embodiment, the fluoropolymer is selected from polyvinylidene fluoride, polytetrafluoroethylene, P(VDF-trifluoroethylene) copolymer, P(VDF-tetrafluoroethylene) copolymer, fluorinated ethylene-propylene, polyethylenetetrafluoroethylene, perfluoropolyether, and combinations thereof. In one embodiment, the electrode comprises 70 wt % inorganic multilayered nanostructures, 15 wt % carbon black and 15 wt % polyvinylidene fluoride.

In one embodiment, B is an element selected from Re, and Nb such that the nanostructures are doped by the B, or wherein the B is an element selected from Fe and Co, such that the nanostructures are alloyed with the B. In one embodiment, the nanostructures are selected from Re doped nanostructures selected from Mo₁₋ₓReₓS₂, W₁₋ₓReₓS₂, Nb doped nanostructures selected from Mo₁₋ₓNbₓS₂, W ,Nb ₓS₂, or Fe or Co alloyed nanostructures selected from Ti₁₋ₓFeₓS₂, Mo₁₋ₓCoₓS₂.

In one embodiment, 0<x≦0.01. In one embodiment, 0<x≦0.005.

In one embodiment, this invention provides an electrochemical cell comprising:
a cathode comprising inorganic multilayered nanostructures;
an anode; and
an electrolyte comprising sodium ions or magnesium ions;
   wherein the cathode and the anode are at least partially submerged within the electrolyte, and wherein the multilayered inorganic nanostructures are selected from inorganic fullerene-like nanoparticles (IF-nanoparticles), inorganic nanotubes (INTs), and any mixture thereof; and wherein the inorganic multilayered nanostructures are of the formula MXₙ, wherein M is of the general formula A₁₋ₓ-Bₓ, wherein x being ≦0.3, provided that x is not zero and A≠B, wherein X is a chalcogenide atom selected from S, Se and Te;
A is a metal atom or transition metal atom or an alloy of metal atoms or transition metal atoms;
B is a metal atom or transition metal atom; and
n is an integer selected from 1 and 2.

In one embodiment, A is a metal atom or transition metal atom or an alloy of metal atoms or transition metal atoms, the atom being selected from Mo, W, Re, Ti, Zr, Hf, Nb, Ta, Pt, Ru, Rh, In, Ga, Sn, Pb, and alloys thereof.

In one embodiment B is a metal atom or transition metal atom, the atom being selected from Si, Li, Nb, Ta, W, Mo, Sc, Y, Hf, Ir, Mn, Ru, Re, Os, V, Au, Rh, Pd, Cr, Co, Fe and Ni.

In one embodiment B is a metal atom or transition metal atom, the atom being selected from Si, Nb, Ta, W, Mo, Sc, Y, Hf, Ir, Mn, Ru, Re, Os, V, Au, Rh, Pd, Cr, Co, Fe and Ni.

In one embodiment, the nanostructures are doped with a B element selected from Re and Nb or alloyed with a B element selected from Fe and Co.

In one embodiment, 0<x≦0.01. In one embodiment, 0<x≦0.005.

In one embodiment, B is an element selected from Re, and Nb such that the nanostructures are doped by the B. In one embodiment, B is an element selected from Fe and Co, such that the nanostructures are alloyed with the B. In one embodiment, the nanostructures are selected from Mo₁₋ₓReₓS ₂, W₁₋ₓReₓS₂, MO₁₋ₓNbₓS₂, W₁₋ₓNbₓS₂, Ti₁₋ₓFeₓS₂ and Mo₁₋ₓCoₓS₂. In one embodiment, the cathode further comprises a carbonaceous material, a fluoropolymer or mixtures thereof. In one embodiment, the carbonaceous material is selected from carbon black, carbon nanotubes and graphene. In one embodiment, the fluoropolymer is selected from polyvinylidene fluoride, polytetrafluoroethylene, P(VDF-trifluoroethylene) copolymer, P(VDF-tetrafluoroethylene) copolymer, fluorinated ethylene-propylene, polyethylenetetrafluoroethylene, perfluoropolyether, and combinations thereof.

In one embodiment, the electrolyte comprises sodium ions, magnesium ions or a combination thereof, in a non-aqueous liquid medium and wherein the cell is a sodium-ion cell or a magnesium-ion cell. In one embodiment, the electrochemical cell is having a reversible capacity of at least 100 mA h g⁻¹ at 20° C.

In one embodiment, the electrochemical cell is an energy storage device. In one embodiment, the electrochemical cell is a battery.

In one embodiment, this invention provides a process for electrochemically intercalation of sodium or magnesium ions into inorganic multilayered nanostructures selected from inorganic fullerene-like nanoparticles (IF-nanoparticles), inorganic nanotubes (INTs), and any combination thereof, the process comprising:
providing an electrochemical cell comprising:
   a cathode comprising the inorganic multilayered nanostructures;
   an anode; and
   an electrolyte;
applying electrical current to the cell;
   wherein the nanostructures are of the formula MXₙ, wherein M is of the general formula A₁₋ₓ-Bₓ,
   wherein x being ≦0.3, provided that x is not zero and A≠B, and wherein
   X is a chalcogenide atom selected from S, Se and Te;
   A is a metal atom or transition metal atom or an alloy of metal atoms or transition metal atoms;
   B is a metal atom or transition metal atom; and
   n is an integer selected from 1 and 2.

In one embodiment, A is a metal atom or transition metal atom or an alloy of metal atoms or transition metal atoms, the atom being selected from Mo, W, Re, Ti, Zr, Hf, Nb, Ta, Pt, Ru, Rh, In, Ga, Sn, Pb, and alloys thereof.

In one embodiment B is a metal atom or transition metal atom, the atom being selected from Si, Li, Nb, Ta, W, Mo, Sc, Y, Hf, Ir, Mn, Ru, Re, Os, V, Au, Rh, Pd, Cr, Co, Fe and Ni.

In one embodiment B is a metal atom or transition metal atom, the atom being selected from Si, Nb, Ta, W, Mo, Sc, Y, Hf, Ir, Mn, Ru, Re, Os, V, Au, Rh, Pd, Cr, Co, Fe and Ni.

In one embodiment, the nanostructures are doped with a B element selected from Re and Nb or alloyed with a B element selected from Fe and Co.

In one embodiment, the intercalation is reversible.
In one embodiment, B is an element selected from Re, and Nb such that the nanostructures are doped by the B. In one embodiment, B is an element selected from Fe and Co, such that the nanostructures are alloyed with the B.

In one embodiment, the nanostructures are selected from Re doped nanostructures selected from Mo₁₋ₓReₓS₂, W₁₋ₓReₓS₂, Nb doped nanostructures selected from Mo₁₋ₓNbₓS₂, W₁₋ₓNbₓS₂, or Fe or Co alloyed nanostructures selected from Ti₁₋ₓFeₓS₂, Mo₁₋ₓCoₓS₂

In one embodiment, 0<x≦0.01.

In one embodiment, the cathode further comprises a carbonaceous material, a fluoropolymer polymer or mixtures thereof. In one embodiment, the carbonaceous material is selected from carbon black, carbon nanotubes, graphene. In one embodiment, the fluoropolymer is selected from polyvinylidene fluoride, polytetrafluoroethylene, P(VDF-trifluoroethylene) copolymer, P(VDF-tetrafluoroethylene) copolymer, fluorinated ethylene-propylene, polyethylenetetrafluoroethylene, perfluoropolyether, and combinations thereof. In one embodiment, the cathode comprises 70 wt % inorganic multilayered nanostructures, 15 wt % carbon black and 15 wt % polyvinylidene fluoride.

In one embodiment, the electrolyte comprises sodium ions in a non-aqueous liquid medium, and wherein the non-aqueous liquid medium is selected from ethylene carbonate, diethyl carbonate and mixtures thereof, and wherein the concentration of the Na⁺ ions in the electrolyte is between about 0.5M and 1M.

In one embodiment, the electrical current is cycled between about 0.7 V and 2.7 V.

In one embodiment, this invention provides a method of use of the electrochemical celldescribed herein above as an energy storage device. In one embodiment, the method comprises connecting the electrochemical cell to a load, such that sodium or magnesium ions are intercalated in the inorganic multilayered nanostructures and electrical current flows through the load.

In one embodiment, the method further comprising:
disconnecting the cell from the load;
connecting the cell to a power supply;
driving charging current to the cell using the power supply, such that the sodium ions or magnesium ions are extracted from the inorganic layered nanostructures.

In one embodiment, following the driving of the charging current, the energy storage device is charged and is ready for subsequent use.

As demonstrated herein, nanosized MoS₂ particles have been evaluated as an intercalation host for Na ion batteries. These systems have shown reversible sodium ion de-intercalation/intercalation and reversible capacity (ca. 140 mA h g⁻¹). The material may thus be utilized as a promising electrode material for Na ion batteries.

Compared to the IF-MoS₂, Re-doped IF-MoS₂ nanoparticles showed excellent electrochemical performances including better rate performance (ca. 100 mAhg⁻¹ at 20 C), and better cycle performance over 30 cycles, as will be further discussed below. Without wishing to be bound by theory, this can be attributed to the following two effects of Re-doped IF-MoS₂:
(1) enhanced electrical conductivity and
(2) an increased amount of diffusion channels (defects) along c-axis.

Therefore, the structural modification of fullerene-like structured compounds via doping appears to be a promising strategy to improve electrochemical performances.

Molybdenum disulfide has a P6₃/mmc space group, where each slab is formed by two layers of hexagonally close packed sulfur atoms sandwiching Mo layer with trigonal prismatic coordination. Noticeably, the stacks are maintained by van der Waals forces along the c-directions in an ABA type packing fashion (2H—MoS₂) allowing the intercalation of guest-ions, atoms or compounds between the layers. The interlayer spacing (c/2) and the distance between sulfur atoms of two layers is ca. 0.62 and 0.31 nm, respectively, which is large enough to intercalate Na ions (diameter of Na ion=0.102 nm).

Inorganic fullerene-like MoS₂ (IF-MoS₂) and Re-doped MoS₂ (Re:IF-MoS₂) nanoparticles (Nb-doped IF-MoS₂) were synthesized through the sulfidation of MoO₃ and ReₓMo₁₋ₓO₃ (x=0.0012) under H₂S and forming gas (1 vol. % H₂ in N₂) environment, respectively. The outer sulfide layers progressed inwards via diffusion controlled mechanism allowing Re doping (the actual rhenium concentration was about 2-3 times smaller than the formal weighted concentration in the oxide precursor, 0.12 at %). N-type doping of inorganic fullerene-like MoS₂ (IF-MoS₂) was accomplished by substituting molybdenum with rhenium resulting in Re-doped MoS₂ nanoparticles (Re:IF-MoS₂).

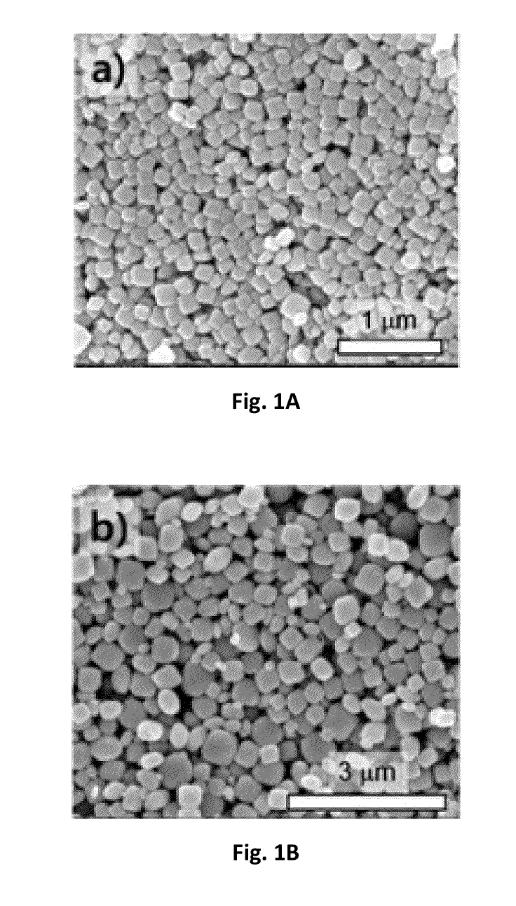

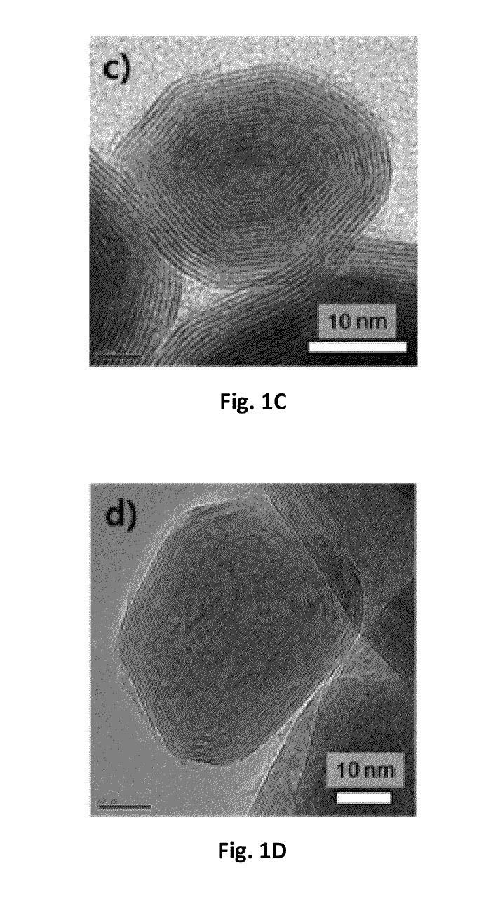

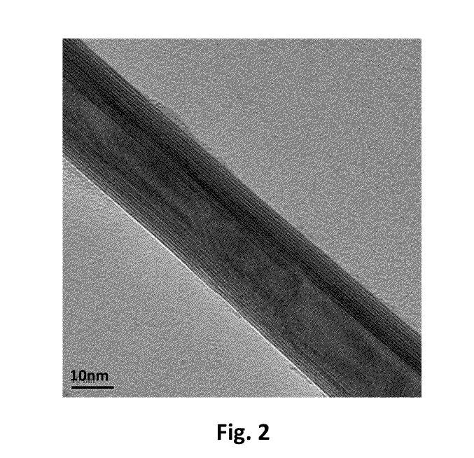

As shown in FIG. 1, SEM images reveal that IF-MoS₂ and Re:IF-MoS₂ nanoparticles have a size range of 30-200 nm and 50-500 nm, respectively. Both types of nanoparticles have the closed cage structures with faceted morphologies, where the number of layers composing the samples is typically larger than 10, as shown in TEM images of FIG. 1. Similarly, typical morphology of WS₂ nanotubes (INT-W₂S) is shown on FIG. 2.

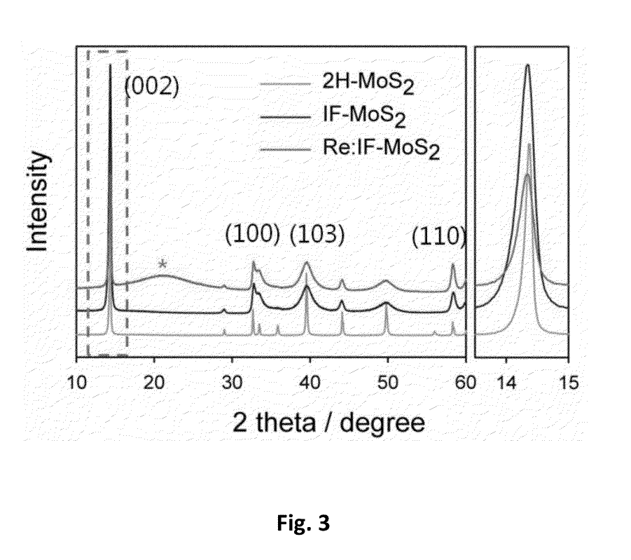

The samples were further examined by XRD analysis (FIG. 3). Pure phases of IF-MoS₂ and Re:IF-MoS₂ nanoparticles were obtained and no impurity peaks were observed. IF-MoS₂ and Re:IF-MoS₂ have a similar line broadness (full width at half maximum (FWHM)) of XRD peaks, although Re:IF-MoS₂ should show smaller FWHM than IF-MoS₂ when considering the larger average particle size of Re:IF-MoS₂. This indicates that they have similar XRD-coherent size regardless of larger particle size of IF-MoS₂. Also, it is notable that the peak intensity ratio of I(002)/I(110) is changed after Re-doping. The I(002)/I(110) ratio (4.95) of Re:IF-MoS₂ is lower than that of IF-MoS₂ (13.4), indicating less crystallinity, i.e., more defects, in Re:IF-MoS₂ along the c-axis, which means that the Re substitution leads to some disorder. Accordingly, it seems that Re-doping induces more defective channels of Re:IF-MoS₂ along the c-axis for Na ion intercalation compared to IF-MoS₂.

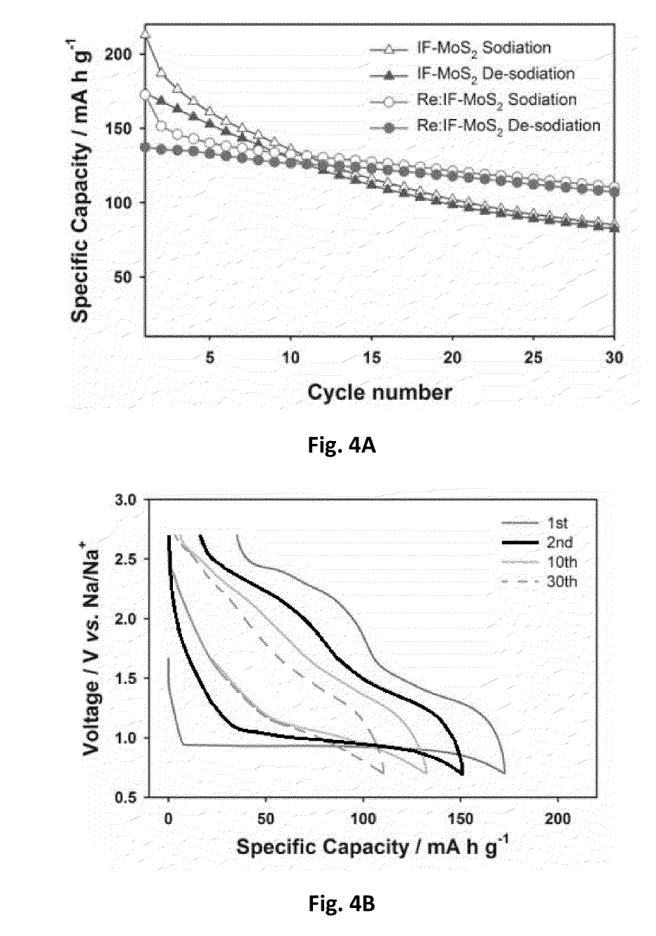

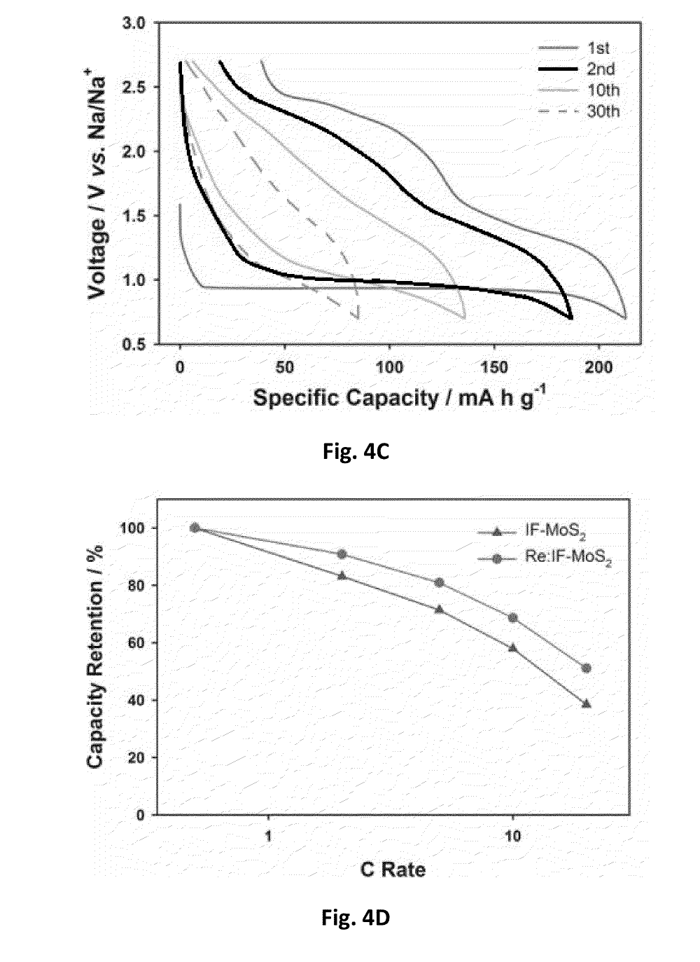

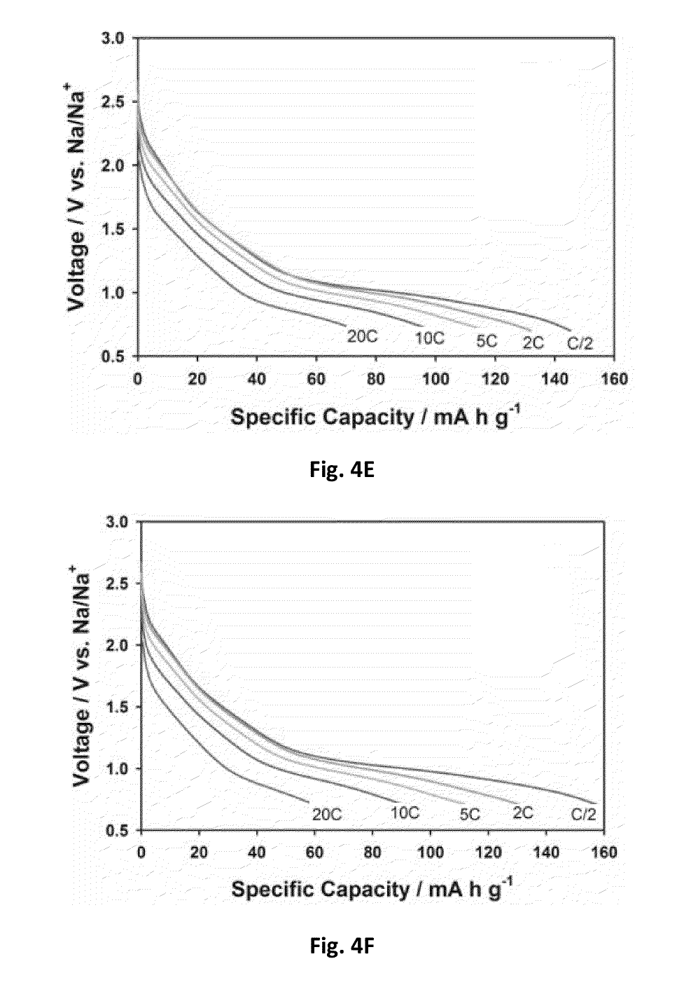

The electrochemical performances of IF-MoS₂ and Re:IF-MoS₂ electrodes were compared (FIG. 4). The cells were cycled in a range between 0.7 V and 2.7 V vs. Na/Na⁺. The Re:IF-MoS₂ electrode showed much more improved cycle performance than the IF-MoS₂ electrode. The capacity retention of each electrode after 30 cycles was 47 and 78% for IF-MoS₂ and Re:IF-MoS₂ electrodes, respectively (FIG. 4A). The two electrodes showed similar voltage profiles at each cycle number, but the Re:IF-MoS₂ exhibited smaller polarization than the IF-MoS₂ as the cycle number increased (FIGS. 4B and 4C).

FIGS. 4D-F present a comparison of the rate performance of the Re:IF-MoS₂ electrode to that of the IF-MoS₂ electrode. The Re:IF-MoS₂ electrode exhibits excellent rate performance delivering ca. 74 mAhg⁻¹ at even a 20 C (ca. 51% capacity retention at 20 C compared to 0.2C), outperforming the IF-MoS₂ electrode (ca. 38% capacity retention at 20 C compared to 0.2 C). These better performances of the Re:IF-MoS₂ can be attributed to two factors including higher electrical conductivity and increased amount of defective channels of Re:IF-MoS₂. The unit “C” (or C-rate) denotes a discharge rate equal to the capacity of the cell (or battery) over a period of one hour.

First, the substitution of Re with Mo in the MoS₂ structure served as n-type doping, resulting in an improved electrical conductivity owing to the increased amount of charge carriers, allowing facile conduction. Previously, Tiong et al. (K. K. Tiong, P. C. Liao, C. H. Ho and Y. S. Huang, Journal of Crystal Growth, 1999, 205, 543-547) reported a dramatic decrease of electrical resistivity with increasing rhenium doping concentration to bulk MoS₂ crystals. Recently, also Re doping of IF-MoS₂ nanoparticles was shown to lead to a remarkable resistivity drop [15].

Second, it should be noted that IF-MoS₂ has a faceted cage structure. To build up the structure with a convex curvature, it requires topological defects including triangles and rhombi to maintain trigonal prismatic coordination. The insertion of Na ions into IF-MoS₂ proceeds through channels composed of crystal defects, dislocations, and stacking faults. Therefore, the diffusion rate of Na ion through the cage structure can be increased as the amount of these channels increases. Apart from the intrinsic defects originated from the cage structure, doping can lead to additional defects. As shown in FIG. 3, the structure of Re:IF-MoS₂ is less crystalline along the c-axis than intrinsic IF-MoS₂. This implies that the amount of diffusion channels increased, resulting in the improved rate performance of Re:IF-MoS₂ as compared to IF-MoS₂, in spite of that the average size of Re:IF-MoS₂ is larger than that of IF-MoS₂. Accordingly, considering that the solid state diffusion of Na ions is the rate-determining step in Na ion batteries, it is notable that the rate capability of Re:IF-MoS₂ is enhanced due to improved electrical conductivity and increased defect sites, despite of longer diffusion length of Re:IF-MoS₂.

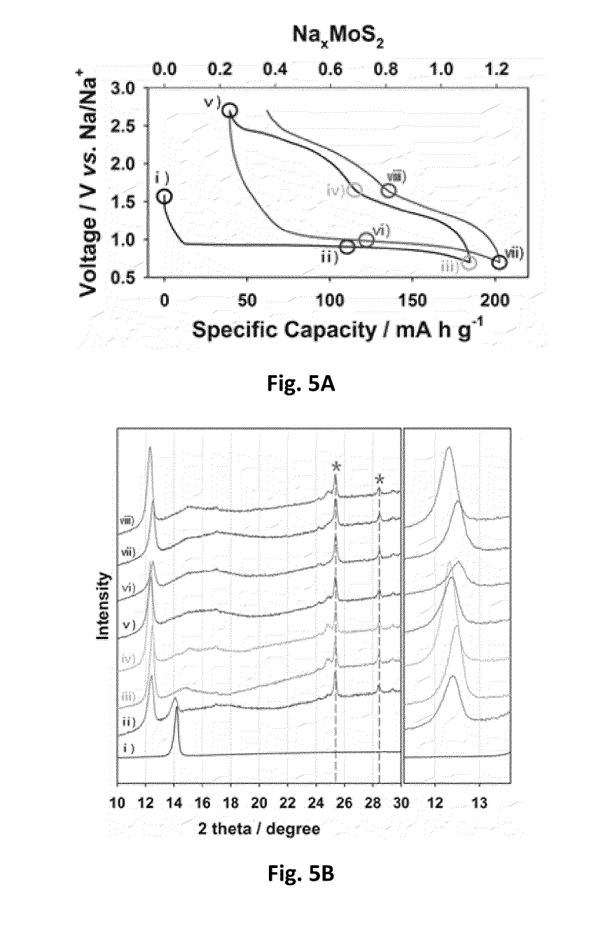

The electrochemical mechanism of reversible Na ion de/intercalation to the host material was examined via an ex-situ XRD analysis using IF-MoS₂ electrodes. The XRD patterns were collected at various points during two cycles, as shown in FIG. 5. As 0.66 Na⁺ (110 mAh g⁻¹) is inserted into IF-MoS₂ (point (ii) on FIG. 5A), the intensity of the (002) peak at 14.1° decreased with the formation of a new peak at 12.4° corresponding to the formation of a Na-rich NaₓMoS₂ phase (x=ca. 1.0 in NaₓMoS₂). The observation of two (002) peaks in XRD pattern (FIG. 5B) indicates the MoS₂ electrode proceeds through a two-phase reaction of MoS₂ and Na-rich NaₓMoS₂ during sodiation at the first cycle. Moreover, the peak shift of XRD peaks corresponding to (002) from 14.1 to 12.4 means that the (002) d-spacing is expanded from 0.627 nm to 0.713 nm along the c-axis due to the intercalated Na ions. After fully discharging until the redox potential reached 0.7 V (point (iii) on FIG. 5A), all MoS₂ peaks disappeared and only XRD peaks indicating the Na-rich NaₓMoS₂ phase remained. The d-spacing of (002) was 0.708 nm after full sodiation. The slight decrease of (002) d-spacing in Na-rich NaₓMoS₂ from 0.713 nm to 0.708 nm indicates that partial solid solubility of the end member, Na-rich NaₓMoS₂ phase, exists. Also, the decrease of (002) d-spacing is attributed to reduced repulsive force between MoS₂ layers due to the attraction between Na cation and S anion, as shown in the example of LiCoO₂.

In contrast to sodiation, upon desodiation until the redox potential reached 1.7 V and 2.7 V (point (iv) and (v) on FIG. 5A), Na-rich NaₓMoS₂ electrode proceeds through a one-phase reaction showing peak shift of NaₓMoS₂ without recovery of additional MoS₂ peaks. The (002) d-spacing is slightly increased from 0.708 nm to 0.714 nm due to the deintercalated Na ions. This indicates that the fully desodiated phase at 2.7 V is not MoS₂ but Na-poor phase of NaₓMoS₂. Accordingly, the Na-poor phase of NaₓMoS₂ proceeds through one-phase reaction during sodiation and desodiation at the 2nd cycle, as shown in FIG. 5. This is supported by the change of voltage profiles from plateau to sloping on cycling, as shown in FIG. 4C.

Experimental Detail

Synthesis of IF-MoS₂ nanoparticles: IF-MoS₂ nanoparticles were prepared as described in [16]. MoO₃ was sulfidized using H₂S under reducing atmosphere (1 vol. % H₂ in N₂) at a temperature above 800° C. inside a furnace.

Synthesis of Re doped IF-MoS₂ (Re:IF-MoS₂) nanoparticles: Re:IF-MoS₂ NPs were synthesized according to [15-18]. ReₓMo₁₋ₓO₃ (x<0.01) was evaporated at 770° C., and then reduced under hydrogen gas at 800° C. inside a quartz reactor to afford Re-doped MoO_{3-y}. The partially reduced oxide was sulfidized under H₂/H₂S at 810-820° C., and then annealed in the presence of a H₂S and forming gas at 870° C. for 25-35 h.

Characterization: Powder X-Ray diffraction (XRD) data were collected on a Rigaku D/MAX2500V/PC powder diffractometer using Cu-Kα radiation (λ=1.5405 Å) operated from 2θ=10-80°. SEM and TEM samples were examined in a Quanta 200 field-emission scanning electron microscope (FE-SEM) and Philips CM120, respectively.

Electrochemical characterization: Samples of electrochemically active materials, i.e. the IF nanoparticles, were mixed with carbon black (Super P) and polyvinylidene fluoride (PVDF) in a 7:1.5:1.5 weight ratio to provide the cathode material. The electrochemical performance was evaluated using 2032 coin cells with a Na metal anode and 0.8 M NaClO₄ in an ethylene carbonate and diethyl carbonate (1:1 v/v) non-aqueous electrolyte solution. Galvanostatic experiments were performed in a range of 0.7-2.7 V vs. Na/Na⁺ at a current density of 20 mA g⁻¹ (0.1 C) and 30° C.

What is claimed is:

1. An electrode comprising inorganic multilayered nanostructures wherein said inorganic multilayered nanostructures are selected from inorganic fullerene-like nanoparticles (IF-nanoparticles), inorganic nanotubes (INTs), and any combination thereof;
wherein said nanostructures are of the formula MXₙ, wherein M is of the general formula
A₁₋ₓ-Bₓ, wherein x being ≦0.3, provided that x is not zero and A≠B, wherein
X is a chalcogenide atom selected from S, Se and Te;
A is a metal atom or transition metal atom or an alloy of metal atoms or transition metal atoms;
B is a metal atom or transition metal atom; and
n is an integer selected from 1 and 2.

2. The electrode of claim 1, wherein:
A is a metal atom or transition metal atom or an alloy of metal atoms or transition metal atoms, said atom being selected from Mo, W, Re, Ti, Zr, Hf, Nb, Ta, Pt, Ru, Rh, In, Ga, Sn, Pb, and alloys thereof; and wherein
B is a metal atom or transition metal atom, said atom being selected from Si, Li, Nb, Ta, W, Mo, Sc, Y, Hf, Ir, Mn, Ru, Re, Os, V, Au, Rh, Pd, Cr, Co, Fe and Ni.

3. The electrode of claim 2, wherein said nanostructures are doped with a B element selected from Re and Nb or alloyed with a B element selected from Fe and Co.

4. The electrode of claim 1, wherein said electrode further comprises a carbonaceous material, a fluoropolymer or mixtures thereof.

5. The electrode of claim 4 wherein said carbonaceous material is selected from carbon black, carbon nanotubes and graphene.

6. The electrode of claim 4, wherein said fluoropolymer is selected from polyvinylidene fluoride, polytetrafluoroethylene, P(VDF-trifluoroethylene) copolymer, P(VDF-tetrafluoroethylene) copolymer, fluorinated ethylene-propylene, polyethylenetetrafluoroethylene, perfluoropolyether, and combinations thereof.

7. The electrode of claim 4, wherein said electrode comprises 70 wt % inorganic multilayered nanostructures, 15 wt % carbon black and 15 wt % polyvinylidene fluoride.

8. The electrode of claim 2, wherein B is an element selected from Re, and Nb such that said nanostructures are doped by said B, or wherein said B is an element selected from Fe and Co, such that said nanostructures are alloyed with said B.

9. The electrode of claim 8, wherein said nanostructures are selected from Re doped nanostructures selected from Mo₁₋ₓReₓS₂, W₁₋ₓReₓS₂, Nb doped nanostructures selected from Mo₁₋ₓNbₓS₂, W₁₋ₓNbₓS₂, or Fe or Co alloyed nanostructures selected from Ti₁₋ₓFeₓS₂, Mo₁₋ₓCo ₓS₂.

10. The electrode of claim 1, wherein 0<x≦0.01.

11. The electrode of claim 10, wherein 0<x≦0.005.

12. An electrochemical cell comprising:
a cathode comprising inorganic multilayered nanostructures;
an anode; and
an electrolyte comprising sodium ions or magnesium ions;
wherein said cathode and said anode are at least partially submerged within said electrolyte, and wherein said multilayered inorganic nanostructures are selected from inorganic fullerene-like nanoparticles (IF-nanoparticles), inorganic nanotubes (INTs), and any mixture thereof; and
wherein said inorganic multilayered nanostructures are of the formula MXₙ, wherein M is of the general formula A₁₋ₓ-Bₓ, wherein x being ≦0.3, provided that x is not zero and A≠B, wherein
X is a chalcogenide atom selected from S, Se and Te;
A is a metal atom or transition metal atom or an alloy of metal atoms or transition metal atoms;
B is a metal atom or transition metal atom; and
n is an integer selected from 1 and 2.

13. The electrode of claim 12, wherein
A is a metal atom or transition metal atom or an alloy of metal atoms or transition metal atoms, said atom being selected from Mo, W, Re, Ti, Zr, Hf, Nb, Ta, Pt, Ru, Rh, In, Ga, Sn, Pb, and alloys thereof and wherein
B is a metal atom or transition metal atom, said atom being selected from Si, Li, Nb, Ta, W, Mo, Sc, Y, Hf, Ir, Mn, Ru, Re, Os, V, Au, Rh, Pd, Cr, Co, Fe and Ni.

14. The electrochemical cell of claim 13, wherein said nanostructures are doped with a B element selected from Re and Nb or alloyed with a B element selected from Fe and Co.

15. The electrochemical cell of claim 12, wherein 0<x≦0.01.

16. The electrochemical cell of claim 12, wherein 0<x≦0.005.

17. The electrochemical cell of claim 14, wherein said B is an element selected from Re, and Nb such that said nanostructures are doped by said B, or wherein said B is an element selected from Fe and Co, such that said nanostructures are alloyed with said B.

18. The electrochemical cell of claim 17, wherein said nanostructures are selected from Mo₁₋ₓReₓS₂, W₁₋ₓReₓS₂, Mo₁₋ₓNbₓS₂, W₁₋ₓNbₓS₂, Ti₁₋ₓFeₓS₂ and Mo₁₋ₓCoₓS₂.

19. The electrochemical cell of claim 12, wherein said cathode further comprises a carbonaceous material, a fluoropolymer or mixtures thereof.

20. The electrochemical cell of claim 19, wherein said carbonaceous material is selected from carbon black, carbon nanotubes and graphene.

21. The electrochemical cell of claim 19, wherein said fluoropolymer is selected from polyvinylidene fluoride, polytetrafluoroethylene, P(VDF-trifluoroethylene) copolymer, P(VDF-tetrafluoroethylene) copolymer, fluorinated ethylene-propylene, polyethylenetetrafluoroethylene, perfluoropolyether, and combinations thereof.

22. The electrochemical cell of claim 12, wherein said electrolyte comprises sodium ions, magnesium ions or a combination thereof, in a non-aqueous liquid medium and wherein said cell is a sodium-ion cell or a magnesium-ion cell.

23. The electrochemical cell of claim 12, having a reversible capacity of at least 100 mA h g⁻¹ at 20° C.

24. The electrochemical cell of claim 12, wherein said electrochemical cell is an energy storage device.

25. The electrochemical cell of claim 24, wherein said electrochemical cell is a battery.

26. A process for electrochemically intercalation of sodium or magnesium ions into inorganic multilayered nanostructures selected from inorganic fullerene-like nanoparticles (IF-nanoparticles), inorganic nanotubes (INTs), and any combination thereof, the process comprising:
providing an electrochemical cell comprising:
a cathode comprising said inorganic multilayered nanostructures;
an anode; and
an electrolyte;
applying electrical current to said cell;
wherein said nanostructures are of the formula MXₙ, wherein M is of the general formula A₁₋ₓ-Bₓ, wherein x being ≦0.3, provided that x is not zero and A≠B, wherein X is a chalcogenide atom selected from S, Se and Te;
A is a metal atom or transition metal atom or an alloy of metal atoms or transition metal atoms;
B is a metal atom or transition metal atom; and
n is an integer selected from 1 and 2.

27. The process of claim 26 wherein:
A is a metal atom or transition metal atom or an alloy of metal atoms or transition metal atoms, said atom being selected from Mo, W, Re, Ti, Zr, Hf, Nb, Ta, Pt, Ru, Rh, In, Ga, Sn, Pb, and alloys thereof; and wherein
B is a metal atom or transition metal atom, said atom being selected from Si, Li, Nb, Ta, W, Mo, Sc, Y, Hf, Ir, Mn, Ru, Re, Os, V, Au, Rh, Pd, Cr, Co, Fe and Ni; and wherein

[symbol]

28. The process of claim 27, wherein said nanostructures are doped with a B element selected from Re and Nb or alloyed with a B element selected from Fe and Co.

29. The process of claim 26, wherein said intercalation is reversible.

30. The process of claim 27, wherein B is an element selected from Re, and Nb such that said nanostructures are doped by said B, or wherein said B is an element selected from Fe and Co, such that said nanostructures are alloyed with said B.

31. The process of claim 30, wherein said nanostructures are selected from Re doped nanostructures selected from Mo₁₋ₓReₓS₂, W₁₋ₓReₓS₂, Nb doped nanostructures selected from Mo₁₋ₓNbₓS₂, W₁₋ₓNbₓS₂, or Fe or Co alloyed nanostructures selected from Ti₁₋ₓFeₓS₂, Mo₁₋ₓCoₓS₂.

32. The process of claim 26, wherein 0<x≦0.01.

33. The process of claim 26, wherein said cathode further comprises a carbonaceous material, a fluoropolymer polymer or mixtures thereof.

34. The process of claim 33, wherein said carbonaceous material is selected from carbon black, carbon nanotubes, graphene.

35. The process of claim 33, wherein said fluoropolymer is selected from polyvinylidene fluoride, polytetrafluoroethylene, P(VDF-trifluoroethylene) copolymer, P(VDF-tetrafluoroethylene) copolymer, fluorinated ethylene-propylene, polyethylenetetrafluoroethylene, perfluoropolyether, and combinations thereof.

36. The process of claim 33, wherein said cathode comprises 70 wt % inorganic multilayered nanostructures, 15 wt % carbon black and 15 wt % polyvinylidene fluoride.

37. The process of claim 26, wherein said electrolyte comprises sodium ions in a non-aqueous liquid medium, and wherein said non-aqueous liquid medium is selected from ethylene carbonate, diethyl carbonate and mixtures thereof, and wherein the concentration of said Na⁺ ions in said electrolyte is between about 0.5M and 1M.

38. The process of claim 26, wherein said electrical current is cycled between about 0.7 V and 2.7 V.

39. A method of use of the electrochemical cell of claim 12 as a energy storage device, said method comprises connecting said electrochemical cell to a load, such that sodium or magnesium ions are intercalated in said inorganic multilayered nanostructures and electrical current flows through said load.

40. The method of claim 39, further comprising:
disconnecting said cell from said load;
connecting said cell to a power supply;
driving charging current to said cell using said power supply, such that said sodium ions or magnesium ions are extracted from said inorganic layered nanostructures.

41. The method of claim 40, wherein following said driving of said charging current, said energy storage device is charged and is ready for subsequent use.
